(19) United States
(12) Patent Application Publication
(10) Pub. No.: US 2025/0200664 A1
(43) Pub. Date: Jun. 19, 2025

(54) GENERATIVE ARTIFICIAL INTELLIGENCE SYSTEM FOR IDENTIFICATION OF UNDERDEVELOPED PROFICIENCY AREAS

(71) Applicant: Wells Fargo Bank, N.A., San Francisco, CA (US)

(72) Inventors: Erin Aine Croll, Des Moines, IA (US); Ann Marie Facciolini, Huntersville, NC (US); Jean Ann Wanish, Charlotte, NC (US); Christina Dorfman, Charlotte, NC (US); Maria Castro, Phoenix, AZ (US)

(21) Appl. No.: 18/545,508

(22) Filed: Dec. 19, 2023

(51) Int. Cl. G06Q 40/06

(52) U.S. Cl. CPC G06Q 40/06

(57) ABSTRACT

Systems, apparatuses, methods, and computer program products are disclosed for identification of an underdeveloped proficiency area for a user. An example method includes generating, by the mining engine, a user attribute set. The example method further includes selecting, by the mining engine and based on the user attribute set, an optimal proficiency identification model. The example method further includes generating, by the multimodal engine and using the optimal proficiency identification model, a user proficiency profile comprising one or more user proficiency areas. The example method further includes identifying, by the multimodal engine and using the optimal proficiency identification model, an underdeveloped proficiency area. The example method further includes outputting, by communications hardware and based on the identified underdeveloped proficiency area, a proficiency development recommendation.

### BACKGROUND

Users that lack essential knowledge into their performance in certain areas typically experience setbacks in achieving both short and long-term goals. Oftentimes, users need to manually evaluate their competencies to identify areas of underdeveloped proficiency areas, and must rely on their own knowledge to devise a plan of action aimed at improving these competencies.

### BRIEF SUMMARY

The implementation of software technologies for identification of underdeveloped proficiency areas has become increasingly important to users, particularly in the context of determining whether the users are meeting certain milestones that are characteristic of their cohort. However, the full extent and applications of underdeveloped proficiency area identification software technologies are still being explored.

While popular applications available in the current market enable automation of financial planning, they are primarily focused on financial proficiency, and do not extend beyond to include the proficiency areas that are related to all aspects of a user's life (e.g., health and wellness, employment, educational, etc.). Furthermore, underserved populations who are traditionally more vulnerable to experiencing setbacks due to limited exposure to proficiency areas, stand to benefit from an innovative technical solution that provides proactive identification of underdeveloped proficiency areas in all aspects, and ensures that users accessing their services receive personalized recommendations to achieve their personal goals. However, as current practices for underdeveloped proficiency area identification rely primarily on self-evaluation, users are unable to identify all proficiency gaps and prioritize the proficiency areas for which targeted improvement is necessary. As such, the manual nature of the proficiency area identification process may lead to users experiencing further inequities and setbacks. In addition, performing manual evaluations of proficiency area identification can also be an administratively burdensome process that can cause challenges in ensuring real-time proficiency area identification and can increase susceptibility to errors, and/or result in misidentification of an underdeveloped proficiency area. As such, there is a unique need for a technical solution that (i) functions independently of any manual activity of a user, (ii) can systematically identify an underdeveloped proficiency area for a user, and (iii) reliably presents a user with a proficiency development recommendation with targeted user actions, that may allow the user to improve their competency in a particular proficiency area. A complex solution of this nature requires a systematic and computer-based implementation. Accordingly, there exists an underlying technical necessity for systems that are able to autonomously provide this capability.

Example implementations described herein provide a technical solution to this technical problem. Moreover, example embodiments overcome the challenges that arise by requiring users to manually evaluate proficiency areas. Example embodiments described herein use an automatic underdeveloped proficiency area identification system including a proficiency identification model. The underdeveloped proficiency area identification system identifies one or more underdeveloped proficiency areas of the user and provides the user with a proficiency development recommendation, and may request the user to indicate their agreement or disagreement with the recommendation. Further, example embodiments iteratively train the proficiency identification model. This allows the model to learn from past misclassifications, adjust its parameters for improved performance, and expedite proficiency area identification for users, significantly reducing processing time.

In one example embodiment, a method is provided for identification of an underdeveloped proficiency area for a user. The method includes generating, by the mining engine, a user attribute set, wherein the user attribute set comprises one or more user attributes. The method further includes selecting, by the mining engine and based on the user attribute set, an optimal proficiency identification model. The method further includes generating, by the multimodal engine and using the optimal proficiency identification model and based on the user attribute set, a user proficiency profile. The method further includes identifying, by the multimodal engine and using the optimal proficiency identification model and based on the one or more proficiency attributes from the one or more user proficiency areas, an underdeveloped proficiency area. The method further includes outputting, by communications hardware and based on the identified underdeveloped proficiency area, a proficiency development recommendation.

In another example embodiment, an apparatus is provided for identification of an underdeveloped proficiency area for a user. The apparatus includes a mining engine configured to generate a user attribute set, wherein the user attribute set comprises one or more user attributes. The mining engine is further configured to select, based on the user attribute set, an optimal proficiency identification model. The apparatus further includes a multimodal engine configured to generate, using the optimal proficiency identification model and based on the user attribute set, a user proficiency profile. The multimodal engine is further configured to identify, using the optimal proficiency identification model and based on the one or more proficiency attributes from the one or more user proficiency areas, an underdeveloped proficiency area. The apparatus further includes communications hardware configured to output, based on the identified underdeveloped proficiency area, a proficiency development recommendation.

In another example embodiment, a computer program product is provided for identification of an underdeveloped proficiency area for a user. The computer program product includes at least one non-transitory computer readable storage medium storing software instructions that, when executed, cause an apparatus to generate a user attribute set, wherein the user attribute set comprises one or more user attributes. The at least one non-transitory computer-readable storage medium storing the software instructions that, when executed, further cause an apparatus to select, based on the user attribute set, an optimal proficiency identification model. The at least one non-transitory computer-readable storage medium storing the software instructions that, when executed, further cause an apparatus to generate, using the optimal proficiency identification model and based on the user attribute set, a user proficiency profile. The at least one non-transitory computer-readable storage medium storing the software instructions that, when executed, further cause an apparatus to output based on the identified underdeveloped proficiency area, a proficiency development recommendation.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for identifying an underdeveloped proficiency area for a user, in accordance with some example embodiments described herein.

FIG. 2 illustrates a schematic block diagram of example circuitry embodying a device that may perform various operations in accordance with some example embodiments described herein.

FIG. 3 illustrates an example flow chart for identifying an underdeveloped proficiency area for a user, in accordance with some example embodiments described herein.

FIG. 4A illustrates an example flowchart for generating a user attribute set, in accordance with some example embodiments described herein.

FIG. 4B illustrates a schematic block diagram of a user attribute set generation framework.

FIG. 5 illustrates an example flowchart for selecting an optimal proficiency identification model, in accordance with some example embodiments described herein.

FIG. 6 illustrates another example flowchart for identifying one or more historical user attribute sets associated with one or more trained proficiency identification models, in accordance with some example embodiments described herein.

FIG. 7 illustrates another example flowchart for generating a user proficiency profile, in accordance with some example embodiments described herein.

FIG. 8A illustrates another example flowchart for identifying an underdeveloped proficiency area, in accordance with some example embodiments described herein.

FIG. 8B illustrates a schematic block diagram of a quantitative difference and qualitative difference identification framework.

FIG. 9 illustrates an example user interface illustrating a proficiency development recommendation used in some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “underdeveloped proficiency area” may refer to a specific domain that a user exhibits a lagging development or deficiency in. In some embodiments, the underdeveloped proficiency area may be identified by an optimal proficiency identification model. In some embodiments, the underdeveloped proficiency area may be associated with one or more proficiency areas, as defined below.

The term “user” may refer to an individual or an entity engaging with the underdeveloped proficiency area identification system. In some embodiments, a user may seek to identify their underdeveloped proficiency areas and receive personalized recommendations that enable them to achieve one or more proficiency goals.

The term “user attribute set” may refer to a collection or group of specific characteristics, traits, or data points associated with an individual user or entity. The user attribute set may be used to select an optimal proficiency identification model for subsequent identification of an underdeveloped proficiency area.

The term “user attributes” may refer to the individual attributes that collectively make up a user attribute set. User attributes may include comprehensive information about the user, such as data pertaining to a user's finances, health, education history, social media profiles, custom attributes and/or the like.

The term “optimal proficiency identification model” may refer to a machine learning model designed to automatically identify an underdeveloped proficiency area of a user. In some embodiments, the optimal proficiency identification model may generate a proficiency development list based on the identified underdeveloped proficiency area.

The term “user proficiency profile” may refer to a digital representation of a user that encapsulates the prior and current state of their proficiency areas. In some embodiments, the user proficiency profile may synthesize information from the user attribute set and proficiency development history, providing a snapshot of the user's proficiency development journey. In some embodiments, the user proficiency profile may be accessed by the optimal proficiency identification model during the operation of identifying an underdeveloped proficiency area.

The term “user proficiency area” may refer to an amalgamated set of proficiency attributes associated with a proficiency area for a particular user. Examples of user proficiency areas may include financial proficiency, health proficiency, educational proficiency, career proficiency, and/or the like.

The term “proficiency area” may refer to an overarching proficiency domain that encompasses the skills and knowledge associated with the specific domain of proficiencies. The proficiency area may be integral to the precise assessment of a user's state of proficiency in different proficiency domains.

The term “user proficiency attributes” may refer to distinct attributes that may be quantitative or qualitative data points associated with the specific domain of the user proficiency area. For example, if the user proficiency area was “financial proficiency-real estate”, the corresponding user proficiency attribute may be “500K invested in a condominium”.

The term “recommended user action” may refer to the specific guidance or steps generated by the optimal proficiency identification model that address the identified underdeveloped proficiency area. For example, a recommended user action may involve allocating a certain percentage of income to retirement savings or paying off high-interest debts.

The term “proficiency development recommendation” may refer to the personalized guidance or steps generated by the optimal proficiency identification model that are outputted to a user. In some embodiments, the proficiency development recommendation may take the user's attribute set, financial goals, current proficiency levels, and/or the like into consideration.

The term “establishment” may refer to a formal entity or organization that provides goods or services (e.g., business entity, organization, commercial entity). In some embodiments, the proficiency development recommendation may be outputted to an establishment, wherein representatives of the establishment may use the proficiency development recommendation to assist a user with their proficiency development.

### System Architecture

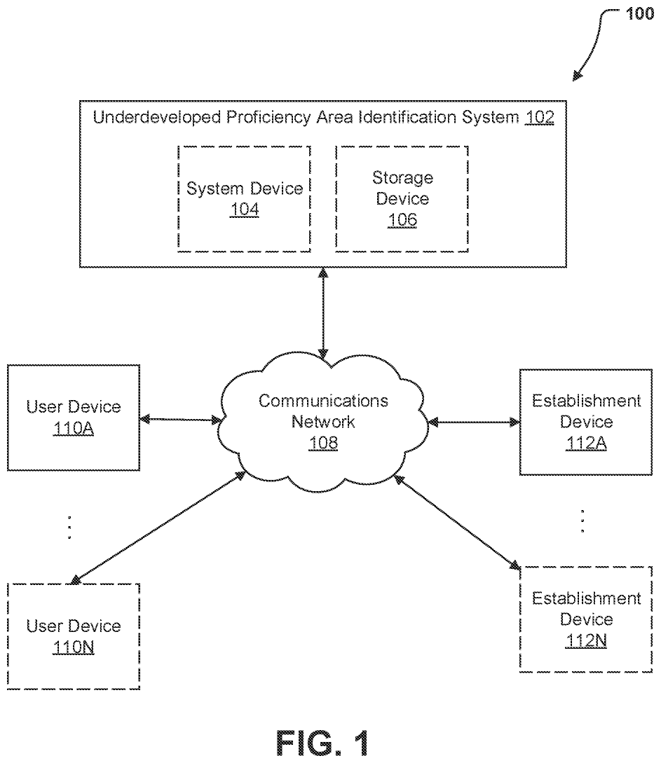

Example embodiments described herein may be implemented using any of a variety of computing devices or servers. To this end, FIG. 1 illustrates an example environment 100 within which various embodiments may operate. As illustrated, an underdeveloped proficiency area identification system 102 may include a system device 104 in communication with a storage device 106. Although system device 104 and storage device 106 are described in singular form, some embodiments may utilize more than one system device 104, more than one storage device 106, and/or the like. Some embodiments of the underdeveloped proficiency area identification system 102 may not require a system device 104 and/or storage device 106 at all. Whatever the implementation, the underdeveloped proficiency area identification system 102 may receive and/or transmit information via communications network 108 (e.g., the Internet) with any number of other devices, such as one or more of user devices 110A-110N and/or establishment devices 112A-112N. A user device 110A-110N may include smartphones, laptops, tablets, and/or the like, whereas an establishment device 112A-112N may be a device associated with an establishment that stores data for the establishment.

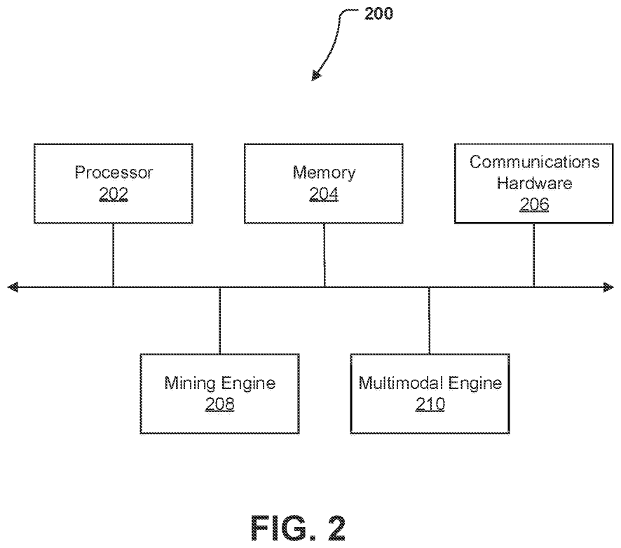

In some embodiments, the underdeveloped proficiency area identification system 102 may be implemented as one or more computing devices or servers, which may be composed of a series of components. These components of system device 104 may be physically proximate to the other components of the underdeveloped proficiency area identification system 102, while other components may not be. The system device 104 may receive, process, generate, and transmit data, signals, and electronic information to facilitate the operations of the underdeveloped proficiency area identification system 102. Particular components of the underdeveloped proficiency area identification system 102 are described in greater detail below with reference to apparatus 200, in connection with FIG. 2.

In some embodiments, the underdeveloped proficiency area identification system 102 further includes a storage device 106 that comprises a distinct component from other components of the underdeveloped proficiency area identification system 102. Storage device 110 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 108). Storage device 110 may host the software executed to operate the underdeveloped proficiency area identification system 102. Storage device 110 may store information relied upon during operation of the underdeveloped proficiency area identification system 102, such as various user attribute sets and proficiency areas that may be used by the underdeveloped proficiency area identification system 102, data and documents to be analyzed using the underdeveloped proficiency area identification system 102, or the like. In addition, storage device 106 may store control signals, device characteristics, and access credentials enabling interaction between the underdeveloped proficiency area identification system 102 and one or more of the user devices 110A-110N or establishment devices 112A-112N.

The one or more user devices 110A-110N and the one or more establishment devices 112A-112N may be embodied by any computing devices known in the art. The one or more user devices 110A-110N and the one or more establishment devices 112A-112N need not themselves be independent devices, but may be peripheral devices communicatively coupled to other computing devices.

Although FIG. 1 illustrates an environment and implementation in which the underdeveloped proficiency area identification system 102 interacts indirectly with a user via one or more of user devices 110A-110N and/or establishment devices 112A-112N, in some embodiments users may directly interact with the underdeveloped proficiency area identification system 102 (e.g., via communications hardware of the underdeveloped proficiency area identification system 102), in which case a separate user device 110A-110N and/or establishment device 112A-112N may not be utilized. Whether by way of direct interaction or indirect interaction via another device, a user may communicate with, operate, control, modify, or otherwise interact with the underdeveloped proficiency area identification system 102 to perform the various functions and achieve the various benefits described herein.

### Example Implementing Apparatuses

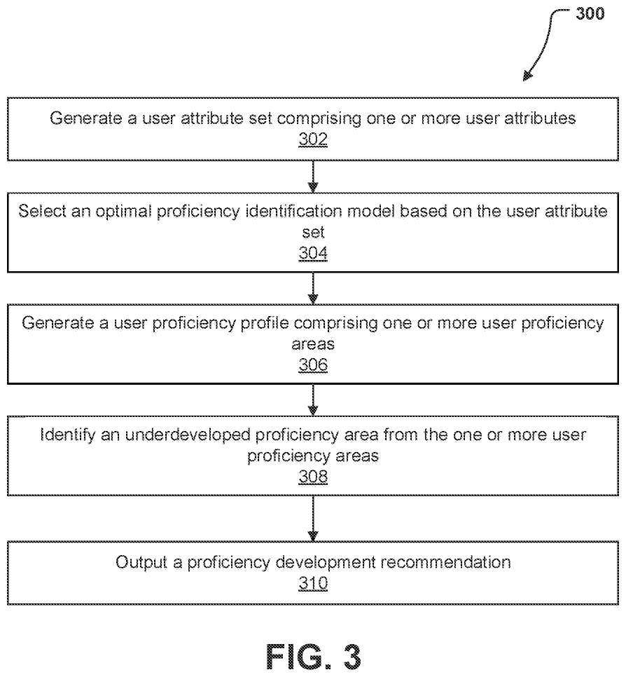

The underdeveloped proficiency area identification system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-10. As illustrated in FIG. 2, the apparatus 200 may include processor 202, memory 204, communications hardware 206, mining engine 208, and multimodal engine 210, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises a mining engine 208 that may be configured to generate a user attribute set comprising one or more user attributes. The mining engine 208 may be further configured to perform this operation by extracting the one or more user attributes pertaining to the user from a plurality of data environments, assigning the one or more user attributes into one or more user attribute types, determining a plurality of inter-attribute type relationships and intra-attribute type relationships based on the one or more user attribute types, and generate the user attribute set based on the plurality of inter-attribute type relationships and intra-attribute type relationships. In some embodiments, the mining engine may be configured to select an optimal proficiency identification model based on the user attribute set. The mining engine may be further configured to perform this operation by identifying one or more historical attribute sets associated with one or more trained proficiency identification models, calculating a similarity score for each of the one or more trained proficiency identification models, and selecting an optimal proficiency identification model based on the similarity score for each of the one or more trained proficiency identification models. The mining engine 208 may utilize processor 202, memory 204, or any other hardware component included in the apparatus 200 to perform these operations, as described in connection with FIGS. 3-5 below. The mining engine 208 may further utilize communications hardware 206 to gather data from a variety of sources (e.g., user devices 110A-110N, establishment devices 112A-112N, storage device 104, or as shown in FIG. 1), and/or exchange data with a user.

In addition, the apparatus 200 further comprises a multimodal engine 210 that uses the optimal proficiency identification model to generate a user proficiency profile based on the user attribute set. The multimodal engine 210 may be further configured to perform this operation by determining, using the optimal proficiency identification model, a user proficiency profile, wherein the user proficiency profile comprises one or more user proficiency areas, wherein each user proficiency area comprises one or more user proficiency attributes. In some embodiments, the multimodal engine 210 may be configured to use the optimal proficiency identification model to identify an underdeveloped proficiency area based on the one or more proficiency attributes from the one or more user proficiency areas. The multimodal engine 210 may be further configured to perform this operation by (i) retrieving a historical proficiency profile associated with one or more historical user attribute sets that the selected optimal proficiency identification model was trained upon, and (iii) identifying at least one quantitative difference or qualitative difference between the user proficiency area and the corresponding historical proficiency area, wherein the at least one quantitative difference or qualitative difference is indicative of the underdeveloped proficiency area. The multimodal engine 210 may utilize processor 202, memory 204, or any other hardware component included in the apparatus 200 to perform these operations, as described in connection with FIGS. 3, 6-7, and 10 below. The multimodal engine 210 may further utilize communications hardware 206 to gather data from a variety of sources (e.g., user devices 110A-110N or establishment devices 112A-112N, storage device 104, or as shown in FIG. 1), and/or exchange data with a user.

Although components 202-210 are described in part using functional language, it will be understood that the particular implementations necessarily include the use of particular hardware. It should also be understood that certain of these components 202-210 may include similar or common hardware. For example, the mining engine 208, and multimodal engine 210 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “engine” with respect to elements of the apparatus therefore shall be interpreted as necessarily including the particular hardware configured to perform the functions associated with the particular element being described. Of course, while the terms “engine” should be understood broadly to include hardware, in some embodiments, the terms “engine” may in addition refer to software instructions that configure the hardware components of the apparatus 200 to perform the various functions described herein.

Although the mining engine 208 and multimodal engine 210 may leverage processor 202, memory 204, or communications hardware 206 as described above, it will be understood that any of mining engine 208 and multimodal engine 210 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that mining engine 208 and multimodal engine 210 comprise particular machinery designed for performing the functions described herein in connection with such elements of apparatus 200.

### Example Operations

Turning to FIGS. 3-10, example flowcharts are illustrated that contain example operations implemented by example embodiments described herein. The operations illustrated in FIGS. 3-10 may, for example, be performed by system device 104 of the underdeveloped proficiency area identification system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, mining engine 208, multimodal engine 210, and/or any combination thereof. It will be understood that user interaction with the underdeveloped proficiency area identification system 102 may occur directly via communications hardware 206, or may instead be facilitated by a separate user device 112A-112N, as shown in FIG. 1, and which may have similar or equivalent physical componentry facilitating such user interaction.

Turning first to FIG. 3, a procedure 300 illustrates example operations for automatically identifying an underdeveloped proficiency area for a user. By automatically identifying an underdeveloped proficiency area for a user, the underdeveloped proficiency area identification system 102 enables the user to avoid any short-term and long-term setbacks due to gaps in certain proficiency areas. For instance, by receiving personalized guidance and recommendations tailored to their specific proficiency gaps, the skill development process becomes streamlined for users, as they may perform targeted learning without expending effort on proficiency areas in which they may already be proficient. In some embodiments, procedure 300 may occur in response to a user inquiry requesting the underdeveloped proficiency area identification system 102 to identify an underdeveloped proficiency area. In some embodiments, procedure 300 may also occur periodically based on a pre-set time frame as indicated by the user or an establishment. For example, the underdeveloped proficiency area identification system 102 may perform procedure 300 on a bi-monthly period for a user seeking to improve their financial proficiency in regards to real-estate investments. Alternatively, the underdeveloped proficiency area identification system 102 may perform procedure 300 on an annual basis for an establishment seeking to assist their customer with improving their financial proficiency in regards to retirement savings.

As shown by operation 302, the apparatus 200 includes means, such as processor 202, memory 204, communications hardware 206, mining engine 208, or the like, for generating a user attribute set comprising one or more user attributes. A user attribute set may refer to a set that encompasses all aspects of information about a particular user, wherein the all-encompassing aspects of information are referred to as user attributes. In particular, a user attribute may be the specific value or string of text constituting: (i) personal identifying information (e.g., full name, date of birth, social security number, address history, email addresses, phone numbers), (ii) criminal history (e.g., arrest records, convictions, warrants), (iii) credit history (e.g., credit reports, credit scores, outstanding debts, bankruptcies), (iv) employment history (e.g., employment verification, job titles and responsibilities, dates of employment), (v) education history (e.g., academic institutions attended, degrees earned, graduation dates, (vi) professional licenses and certifications (e.g., verification of licenses, certification status), (vii) social media presence (e.g., online profiles, social media activity), (viii) driving records (e.g., license status), (ix) applicable military service records (e.g., verification of military service, discharge status), (x) health records (e.g., medical history, drug prescriptions), (xi) cultural associations (e.g., languages spoken), (xii) socioeconomic profile (e.g., access to resources, income bracket), and/or the like. In some embodiments, the user attribute set may not include all the aforementioned user attributes, and may only comprise attributes for which information is found, and for which legal and privacy regulation compliance is maintained.

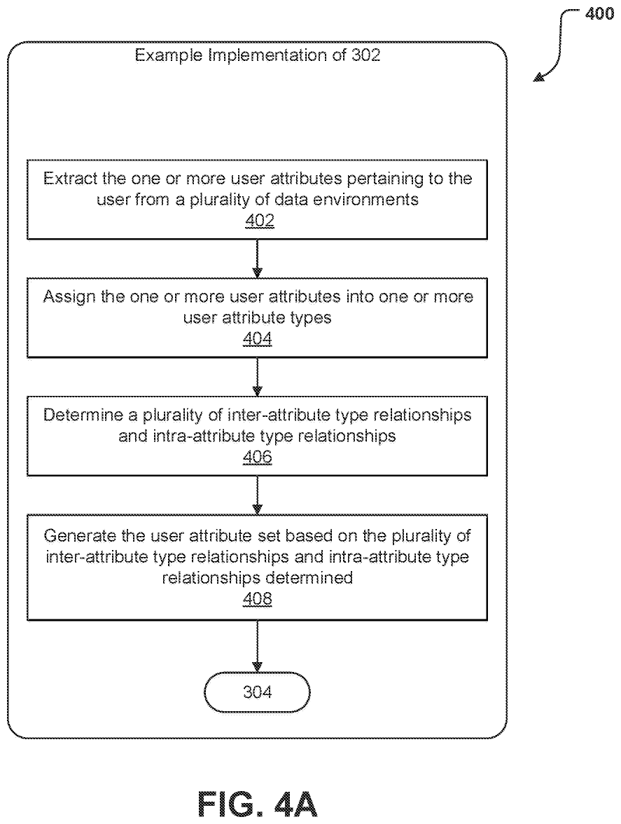

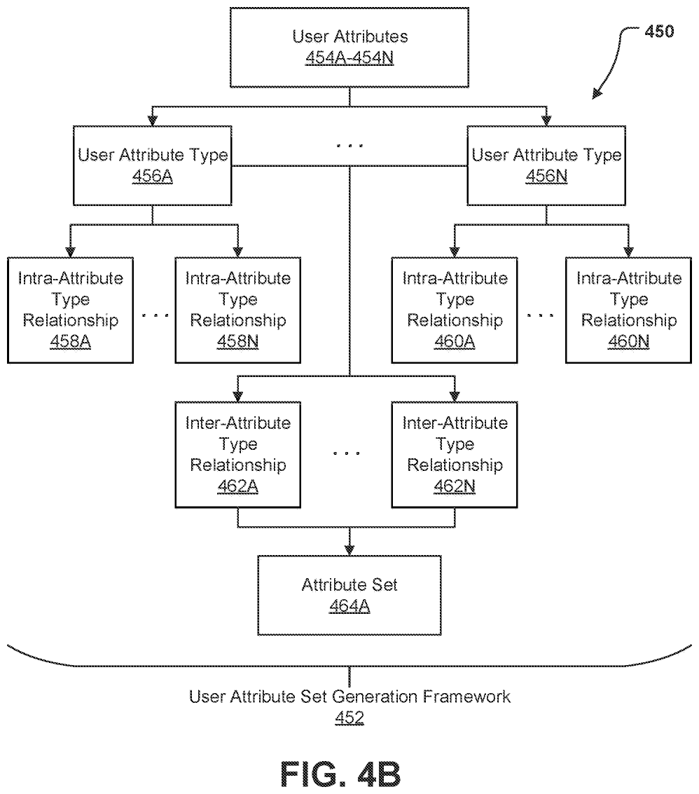

In some embodiments, operation 302 may be performed in accordance with the operations described in FIG. 4A and the corresponding schematic block diagram of FIG. 4B. Turning now to FIGS. 4A-4B, a procedure 400 and schematic block diagram 450 illustrate example operations for generating a user attribute set 464A-464N comprising one or more user attributes 454A-454N.

As shown by operation 402, the apparatus 200 includes means, such as processor 202, memory 204, communications hardware 206, mining engine 208, or the like, for extracting the one or more user attributes 454A-454N pertaining to a user from a plurality of data environments. A plurality of data environments may refer to a structured or unstructured collection of distinct data repositories within which user attributes may be stored. In some embodiments, the plurality of data environments may encompass various sources such as online platforms, applications, databases, or interconnected systems, each containing relevant user attributes for a user. In some embodiments, the plurality of data environments may be accessed from within a user device 110A-110N or establishment device 112A-112N. The communications hardware 206 may establish one or more secure connections with the plurality of data environments. Further, the communications hardware 206 may also access memory 204 to deploy a user attribute extraction algorithm that is configured to extract the one or more user attributes 454A-454N from the plurality of data environments. The user attribute extraction algorithm may comprise a set of instructions that specify how to access, retrieve, and/or store the one or more user attributes 454A-454N. In example embodiments, the user attribute extraction algorithm may include parameters such as (i) data source locations (e.g., relational databases such as MySQL, cloud storage such as Google Cloud, API endpoints, file systems, social media platforms, etc.), (ii) data format specifications (e.g., JavaScript object notation (JSON), extensible markup language (XML), comma-separated values (CSV), database schema, etc.), (iii) extraction criteria, and/or the like. Upon accessing the user attribute extraction algorithm from memory 204, the communications hardware 206 may trigger the mining engine 208 to perform the extraction operation. Subsequently, the mining engine 208 may employ processor 202 to process the one or more extracted user attributes 454A-454N in real-time. Data processing by the processor 202 may involve cleaning, transforming, and/or organizing the extracted user attributes 454A-454N for storage in memory 204. Upon completion of the extraction operation, the mining engine 208 may provide the one or more extracted user attributes 454A-454N to the communications hardware 206 for further processing or analysis.

As shown by operation 404, the apparatus 200 includes means, such as processor 202, memory 204, communications hardware 206, mining engine 208, or the like, for assigning the one or more extracted user attributes 454A-454N into one or more user attribute types 456A-456N. The user attribute type 456A-456N may be a label associated with a user attribute 454A-454N that dictates the type of user information a particular user attribute 454A-454N pertains to. Examples of user attribute types 456A-456N may include: (i) demographics, (ii) finances, (iii) employment, (iv) health, (v) digital presence, (vi) legal history, (xi) cultural associations (e.g., languages spoken), (xii) socioeconomic profile (e.g., access to resources, income bracket), and/or the like. The user attribute types 456A-456N may already be pre-defined by processor 202 and stored in memory 204 based on an analysis of historically extracted user attributes 454A-454N. In some embodiments, the processor 202 may periodically update old user attribute type 456A-456N categories and develop new user attribute type 456A-456N categories based on one or more of newly extracted user attributes 454A-454N. The new user attribute type categories 456A-456N may be stored in memory 204.

The mining engine 208 may use communications hardware 206 to access the user attribute types 456A-456N from memory 204 and perform detailed analyses on the extracted user attributes 454A-454N to determine the corresponding user attribute type 456A-456N. In some embodiments, the mining engine 208 may analyze a user attribute 454A-454N and determine that the user attribute 456A-456N may be related to more than one user attribute type 456A-456N. In such cases, the mining engine 208 may also assign a plurality of user attribute types 456A-456N to a user attribute 454A-454N. Alternatively, the mining engine 208 may perform attribute categorization analysis by quantifying and visually representing the degree or relevance or correlation between a user attribute 454A-454N and the various predefined user attribute types 456A-456N. This analysis may involve evaluating the user attribute 454A-454N across the user attribute types 456A-456N, and generating a ratio or percentage, providing insights into the significance of the user attribute 454A-454N within each user attribute type 456A-456N. For example, the user attribute “credit score: 650” may be related to 70% to the financial attribute type, 15% to the demographics attribute type, and 15% to the employment user attribute type. In this case, this user attribute may be assigned to the user attribute type with the highest percentage relevance, the financial attribute type. When assigning a user attribute type 456A-456N to a user attribute 454A-454N, the mining engine 208 may also take into consideration any user-defined criteria or preferences. If the underdeveloped proficiency area identification system 102 has received indication that the user seeks to improve financial proficiency, the mining engine 208 may weigh the financial user attribute type more heavily in comparison to the other user attribute types 456A-456N. For example, if the user attribute “credit score: 650” was determined to have a 50% relevance to “financial” and 50% relevance to “employment”, the mining engine 208 may assign the financial user attribute type to the user attribute, as the user has indicated financial proficiency improvement as a priority.

As shown by operation 406, the apparatus 200 includes means, such as processor 202, memory 204, communications hardware 206, mining engine 208, or the like, for determining a plurality of inter-attribute type relationships 462A-462N, and intra-attribute type relationships 458A-458N and 460A-460N based on the one or more user attribute types 456A-456N.

Intra-attribute type relationships 458A-458N and 460A-460N may be determined by intra-attribute type analyses. An intra-attribute type analysis involves examining relationships, patterns, and correlations between the same user attribute type 456A or 456N. For example, conducting an intra-attribute type analysis may involve exploring the relationship between a user attribute 1 (e.g., real-estate investments) associated with the financial user attribute type and a user attribute 2 (e.g., retirement investments) associated with the same financial user attribute type. The communications hardware 206 may access one or more intra-attribute type analysis algorithms from memory 204 to perform intra-attribute type analyses. The intra-attribute type analysis algorithm may comprise a set of instructions that specify how to perform intra-attribute type analyses using, (i) descriptive statistics analysis, wherein user attributes within a specific user attribute type are analyzed to reveal patterns, central tendencies, variations (e.g., analyzing the distribution of credit scores and investments within the user population), (ii) time-series analysis, wherein changes to user attributes within a specific user attribute type are tracked over time to identify trends, seasonality, or recurring patterns (e.g., tracking the employee wages and the employer changes to identify patterns in job changes), (iii) distribution analysis, wherein the distribution of user attributes within a specific user attribute type are analyzed to identify the spread and concentration of particular characteristics (e.g., analyzing the distribution of education levels and gender to identify whether limitations to education access are existent for a particular gender), and/or the like. The results of the intra-attribute type analyses may define the intra-attribute type relationships 458A-458N and 460A-460N that may exist within a particular user attribute type 456A or 456N. The mining engine 208 may store the identified intra-attribute type relationships 458A-458N and 460A-460N in memory 204.

Conversely, inter-attribute type relationships 462A-462N may be determined by inter-attribute type analyses. An inter-attribute type analysis involves examining relationships, patterns, and correlations between different user attribute types 456A-456N. For example, conducting an inter-attribute type analysis may involve exploring the relationship between a financial user attribute type (e.g., debt-to-income ratio) and an educational user attribute type (e.g., highest degree earned). The communications hardware 206 may access one or more inter-attribute type analysis algorithms from memory 204 to perform inter-attribute type analyses. The inter-attribute type analysis algorithm may comprise a set of instructions that specify how to perform inter-attribute type analyses using, (i) correlation analysis, wherein the statistical relationship between pairs of user attribute types are measured to determine how changes in one attribute type may correspond to changes in the other (e.g., examining the correlation between a user's income level and their education level to determine whether higher education correlates with higher income), (ii) factor analysis, wherein underlying factors that may explain patterns observed across multiple attribute types are identified (e.g., investigating if there are underlying factors that contribute to both credit scores and employment wages), (iii) clustering analysis, wherein groups of similar users are clustered based on multiple user attribute types (e.g., grouping users based on their demographics, financial behaviors, and employment history to identify distinct user segments), and/or the like. The results of the inter-attribute type analyses may define the inter-attribute type relationships 462A-462N that may exist between one or more user attribute types 456A-456N. The mining engine 208 may store the identified inter-attribute type relationships 462A-462N in memory 204.

Finally, as shown by operation 408, the apparatus 200 includes means, such as processor 202, memory 204, communications hardware 206, mining engine 208, or the like, for generating the user attribute set 464A based on the plurality of inter-attribute type relationships 462A-462N and intra-attribute type relationships 458A-458N and 460A-460N. In some embodiments, the user attribute set 464A may be generated using one or more data structures. The mining engine 208 may select the one or more data structure types based on the characteristics of the extracted user attributes 454A-454N and the determined inter-attribute type relationships 462A-462N and intra-attribute type relationships 458A-458N and 460A-460N. For example, if the mining engine 208 has identified complex inter-attribute type relationships 462A-462N for a user, the mining engine 208 may opt to generate the user attribute set 464A in a graphical format. In some embodiments, the mining engine 208 may prioritize the selection of a user-friendly data structure, or a data structure that would be most compatible for use with subsequent operations. The processor 202 may access memory 204 via communications hardware 206 to deploy a data structure formatting algorithm comprising instructions on how to process the user attributes 454A-454N, inter-attribute type relationships 462A-462N, and intra-attribute type relationships 458A-458N and 460A-460N to determine the optimal data structure for the user attribute set 464A of a particular user. Examples of data structures may include: (i) a hierarchical data structure, wherein each user is a node and the different user attribute types 456A-456N are sub-nodes, under which the inter-attribute type relationships 462A-462N, and intra-attribute type relationships 458A-458N and 460A-460N may be organized, (ii) a tabular data structure, wherein each row may correspond to a user, and each column represents a user attribute type 456A-456N, a user attribute 454A-454N, and the inter-attribute type relationships 462A-462N and intra-attribute type relationships 458A-458N and 460A-460N, (iii) a graph data structure, wherein the nodes represent users, user attributes 454A-454N and the edges represent the inter-attribute type relationships 462A-462N and intra-attribute type relationships 458A-458N and 460A-460N, (iv) a relational database model, wherein individual tables are generated for users, user attribute types 456A-456N, user attributes 454A-454N, and organized in a format to represent the inter-attribute type relationships 462A-462N and intra-attribute type relationships 458A-458N and 460A-460N, and/or the like. In some embodiments, the generated user attribute set 464A may comprise all user attributes 454A-454N and the associated inter-attribute type relationships 462A-462N and intra-attribute type relationships 458A-458N and 460A-460N. Conversely, in some embodiments, the mining engine 208 may generate a user attribute set 464A with a subset of the user attributes 454A-454N and a subset of the associated inter-attribute type relationships 462A-462N and intra-attribute type relationships 458A-458N and 460A-460N, particularly in instances where a user has indicated their preference for improving specific proficiency areas.

Returning to FIG. 3, as shown by operation 304, the apparatus 200 includes means such as processor 202, memory 204, communications hardware 206, mining engine 208, or the like, for selecting an optimal proficiency identification model based on the user attribute set. The mining engine 208 may select an optimal proficiency identification model from one or more trained proficiency identification models and based on an analysis of one or more user attributes and the associated inter-attribute type relationships and intra-attribute type relationships. The selected optimal proficiency identification model may reflect a training history involving a historical attribute set comprising historical attributes that exhibit a certain level of similarity to the user attributes in the user attribute set for a particular user.

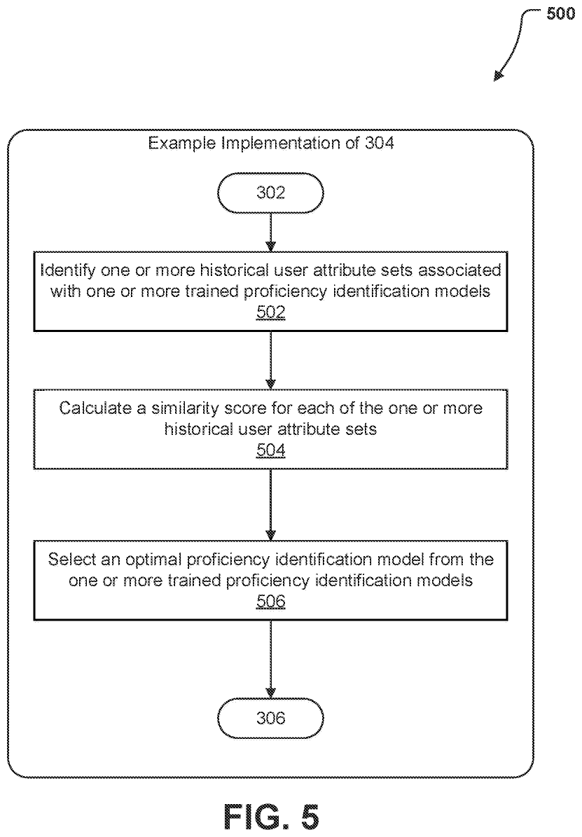

In some embodiments, operation 304 may be performed in accordance with the operations described by FIG. 5. Turning now to FIG. 5, a procedure 500 illustrates example operations for selecting an optimal proficiency identification model based on the user attribute set.

As shown by operation 502, the apparatus 200 includes means, such as processor 202, memory 204, communications hardware 206, mining engine 208, or the like, for identifying one or more historical user attribute sets, wherein the one or more historical user attribute sets are associated with one or more trained proficiency identification models. A historical user attribute set may be associated with a historical user and comprise one or more historical user attributes. A historical user may refer to an individual or an entity that previously engaged with the underdeveloped proficiency area identification system 102. During a historical event for the identification of an underdeveloped proficiency area for a historical user, the following operations may have occurred in accordance with the operations of procedure 400 of FIG. 4A, as described in detail above: (i) assigning of the one or more historical user attributes into the one or more historical user attribute types, and (ii) determining a plurality of inter-historical attribute type relationships and intra-historical attribute type relationships. The generated attribute set for the historical user (i.e., the historical user attribute set) may have stored the associated historical user attribute types, and inter-historical attribute type relationships and intra-historical attribute type relationships in memory 204.

The historical user attribute set may refer to a set that encompasses all aspects of information about a particular historical user, wherein the all-encompassing aspects of information are referred to as historical user attributes. In particular, a historical user attribute may be the specific value or string of text constituting: (i) personal identifying information (e.g., full name, date of birth, social security number, address history, email addresses, phone numbers), (ii) criminal history (e.g., arrest records, convictions, warrants), (iii) credit history (e.g., credit reports, credit scores, outstanding debts, bankruptcies), (iv) employment history (e.g., employment verification, job titles and responsibilities, dates of employment), (v) education history (e.g., academic institutions attended, degrees earned, graduation dates, (vi) professional licenses and certifications (e.g., verification of licenses, certification status), (vii) social media presence (e.g., online profiles, social media activity), (viii) driving records (e.g., license status), (ix) applicable military service records (e.g., verification of military service, discharge status), (x) health records (e.g., medical history, drug prescriptions), and/or the like. In some embodiments, the historical user attribute set may not include all the aforementioned historical user attributes, and may only comprise historical user attributes for which information is found, and for which legal and privacy regulation compliance is maintained. A historical user attribute set may be stored in memory 204.

In some embodiments, the communications hardware 206 may access memory 204 to deploy a historical user attribute set retrieval algorithm that is configured to extract the one or more historical user attribute sets from memory 204. The historical user attribute set extraction algorithm may comprise a set of instructions that specify how to access and extract the one or more historical user attributes. Upon extraction of the one or more historical user attribute sets from memory 204, the communications hardware 206 may transmit the extracted historical user attribute sets to the mining engine 208 for further processing and analysis.

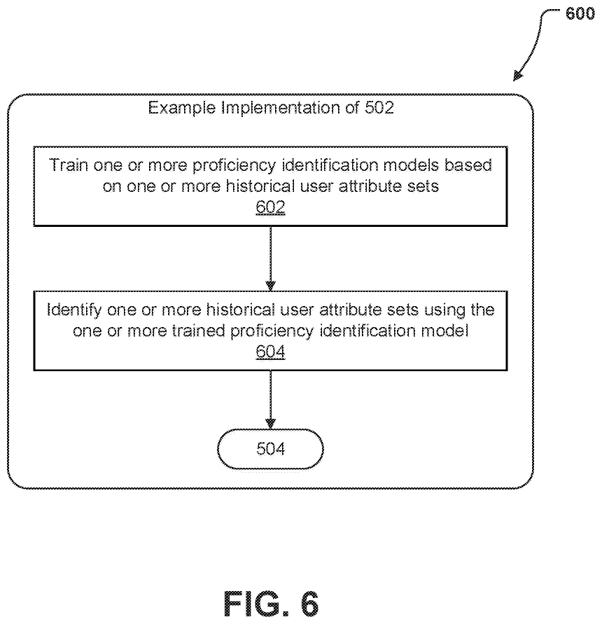

In some embodiments, operation 502 may be performed upon the availability of one or more trained proficiency identification models that are associated with the one or more historical user attribute sets, and in accordance with the operations of FIG. 6. Turning now to FIG. 6, a procedure 600 illustrates example operations for training a proficiency identification model.

As shown by operation 602, the apparatus 200 includes means, such as processor 202, memory 204, communications hardware 206, mining engine 208, or the like, for training one or more proficiency identification models based on one or more historical user attribute sets, wherein the one or more trained proficiency identification models are associated with the one or more historical user attribute sets used during training. In example embodiments, training of the one or more proficiency identification models may occur as follows: (i) data preprocessing wherein the multimodal engine 210 cleans and preprocesses the historical user attributes from the historical user attribute set to handle any missing values, outliers, or data quality issues, (ii) feature engineering wherein the multimodal engine 210 may create or extract features from the historical user attribute set that may be relevant for identifying an underdeveloped proficiency area, (iii) splitting the historical user attribute set wherein the multimodal engine 210 divides the engineered dataset into a training set and testing set, (iv) selecting an appropriate machine learning classification algorithm (e.g., logistic regression, decision trees, random forests, support vector machines, or neural networks), (v) training one or more proficiency identification models using the training data, (vi) evaluating the each proficiency identification model's performance using the testing dataset and an accuracy metric, (vii) fine-tuning the model's hyperparameters such as learning rate, regularization strength or tree depth, depending on the chosen algorithm to optimize its performance, (viii) performing k-fold cross-validation on the training data to assess the model's generalization performance to ensure that the model does not over fit the training data, (ix) analyze the importance of different features in identifying an underdeveloped proficiency area, and (x) choosing the best-performing model based on evaluation metrics and cross-validation results. For every event where the underdeveloped proficiency area identification system 102 is triggered, the multimodal engine 210 may gather and store the generated user attribute set as a historical user attribute set in memory 204 for the iterative training of the one or more proficiency identification models.

In some embodiments, a proficiency identification model may be trained particularly with a historical user attribute set comprising historical user attributes for a specific cohort, such as (i) a female identifying person of 20 years of age, (ii) male identifying person of 25 years of age, (iii) single parent of 30 years of age, (iv) widow of 45 years of age, and/or the like. In some embodiments, the proficiency identification model may self-designate one or more cohort labels describing the specific cohort of historical user attribute sets they were trained upon. For instance, if a user is determined to be of 55 years of age and nearing retirement, the communications hardware 206, in conjunction with multimodal engine 210, may look for trained proficiency identification models associated with a cohort label of “age range: 50-55” and “retirement”.

Returning to FIG. 5, as shown by operation 504, the apparatus 200 includes means, such as processor 202, memory 204, communications hardware 206, mining engine 208, or the like, for calculating a similarity score for each of the one or more historical user attribute sets, wherein the similarity score is a measure of similarity between the one or more historical user attribute sets and the user attribute set. In some embodiments, the processor 202 may preprocess the identified historical user attribute sets to prepare them for subsequent comparison analyses against the user attribute set for a given user. In example embodiments, the processor 202 may preprocess the extracted historical user attribute sets by performing the following: (i) data cleaning by identifying and handing missing or erroneous data in the historical user attribute set, (ii) normalization/scaling by standardizing numerical attributes to a common scale, thereby ensuring that all historical user attributes contribute equally to the subsequent comparison analysis, (iii) feature engineering by creating new relevant features or by modifying existing ones to enhance the information available for analysis, (iv) outlier detection and handling to prevent them from disproportionately influencing the analysis, (v) data encoding by converting categorical variables into a numerical format suitable for analysis, (vi) dimensionality reduction by reducing the number of historical user attributes while preserving relevant information, (vii) temporally aligning the historical user attributes to make them comparable with the user attribute set, (viii) aggregating data to provide a generalized view of historical trends, (ix) handling sequential historical user attributes to account for the temporal order of events, and/or the like.

Memory 204 may store one or more comparison analysis algorithms. As such, in some embodiments, the communications hardware 206 may access memory 204 to deploy the optimal comparison analysis algorithm from the one or more comparison analysis algorithms that is optimally configured to compare the one or more identified historical user attribute sets against a user attribute set. The optimal comparison analysis algorithm may comprise a set of instructions that specify the optimal method for comparing the one or more historical user attribute sets against the user attribute set, and by way of doing so, identify the one or more historical user attribute sets that are the most similar to the user attribute set. In some embodiments, the selection of the optimal comparison method may depend on the characteristics of the historical user attribute set, the desired level of granularity, and the specific aspects of similarity that have been identified by mining engine 208 as being the most relevant to the user's proficiency improvement goals. Example methods for performing a comparison analysis may include the following: (i) performing similarity metrics analysis, (ii) clustering analysis, (iii) pattern recognition techniques, (iv) deploying a classification model, (v) performing a time series analysis, (vi) embedding techniques, (vii) neural network analyses, and/or the like. In some embodiments, the optimal comparison analysis algorithm may combine multiple methods to enhance the accuracy and robustness of the comparison analysis. The mining engine 208 may calculate a similarity score for each of the one or more historical user attribute sets upon the completion of the comparison analysis.

In some embodiments, calculating a similarity score may involve (i) assigning weights to individual user attributes and historical user attributes based on their importance, and determining the weighted sum, (ii) performing feature-level aggregation wherein similarity scores are aggregated at the feature level before computing an overall similarity score, (iii) employing a custom scoring function that captures the specific characteristics of the historical user attribute sets and the user attribute sets, (iv) threshold based scoring wherein predefined thresholds are set to categorize to degree of similarity, and/or the like. The calculated similarity score may be represented as a numerical value (e.g., ranking 10 historical user attribute sets from 1-10, with 1 being the most similar and 10 being the least similar), a string of text (e.g., “historical user attribute set 1 and 5 are the most similarity”), a combination of both numerical values and a string of text, and/or the like.

Finally, as shown by operation 506, the apparatus 200 includes means, such as processor 202, memory 204, communications hardware 206, mining engine 208, or the like, for selecting an optimal proficiency identification model from the one or more trained proficiency identification models, wherein the similarity score of the one or more historical user attribute sets associated with the selected optimal proficiency identification model satisfy a predefined threshold. In some embodiments, the criteria for selecting the optimal proficiency identification model based on the calculated similarity score may be pre-defined and stored in memory 204. Example methods for selection may be based on: (i) the highest calculated similarity score which prioritizes consistency in similarity across various user attributes and historical user attributes, (ii) the maximum similarity in a critical user attribute which is crucial for underdeveloped proficiency identification, (iii) a weighted sum of similarity scores which prioritizes certain user attributes and historical user attribute comparisons more heavily, based on their significance for underdeveloped proficiency identification, (iv) historical user attribute sets that demonstrate consistency and high similarity across multiple user attributes, (v) the highest confidence of the proficiency identification model, (vi) balance across proficiency areas, wherein the historical user attribute sets exhibit well-balanced similarity scores across different proficiency areas, avoiding extreme disparities, (vii) the historical user attribute set with the highest minimum similarity score across all calculated scores, wherein proficiency identification in the least similar user attribute is prioritized, thereby ensuring a minimum level of proficiency in all areas, (viii) emphasis on a particular proficiency area wherein the historical user attributes belonging to the particular proficiency area may be assigned a higher weight to its similarity score, and/or the like. The communications hardware 206 may retrieve the criteria for selecting the optimal proficiency identification model from memory 204. In some embodiments, the processor 202 may also deploy an optimal model selection algorithm, in conjunction with the mining engine 208, wherein the optimal model selection algorithm houses the instructions for selecting the optimal proficiency identification model.

Returning to FIG. 3, as shown by operation 306, the apparatus 200 includes means such as processor 202, memory 204, communications hardware 206, multimodal engine 210, or the like, for generating a user proficiency profile. The user proficiency profile may be a digital representation of a user that encapsulates the prior and current state of their proficiency areas. In some embodiments, the user proficiency profile may synthesize information from the user attribute set and proficiency development history, providing a snapshot of the user's proficiency development journey. In some embodiments, the user proficiency profile may be accessed by the optimal proficiency identification model during the operation of identifying an underdeveloped proficiency area.

A user proficiency profile may be a comprehensive representation of a user's proficiency across various proficiency areas. The user proficiency profile may encompass information about the user's strengths, weaknesses, and levels of competence in specific proficiency areas. A user proficiency area may be a distinct domain or category that encapsulates different aspects of a user's skills, knowledge, or achievements. Each user proficiency area provides insights into the user's proficiency in a specific context. Examples of user proficiency areas may include financial literacy, career development, health and wellness, and/or the like. A user proficiency attribute may be the individual characteristics or metrics within a user proficiency area that contribute to assessing the user's proficiency level. These user proficiency attributes may provide detailed insights into different facets of the user's capabilities. Examples of user proficiency attributes may include (i) financial literacy attributes such as budgeting, investment knowledge, debt management, (ii) career development attributes such as skill acquisition, networking, goal setting, (iii) health and wellness attributes such as physical fitness, stress management, nutritional awareness, and/or the like.

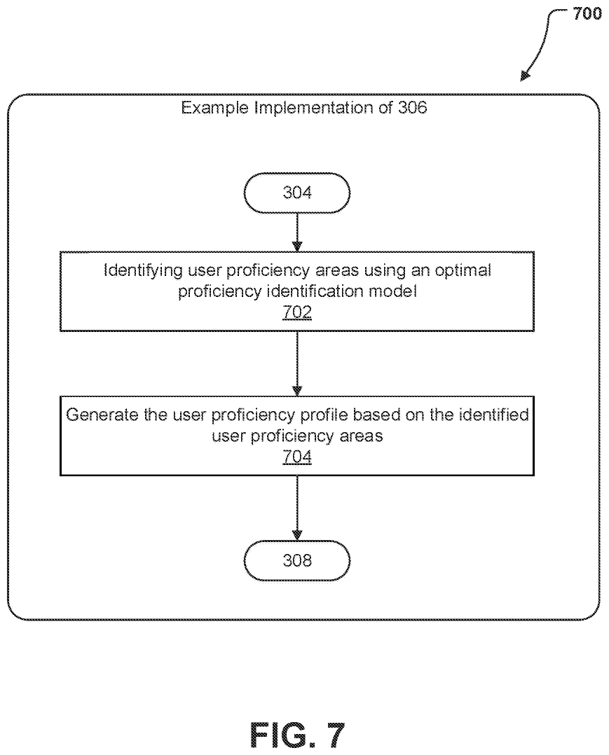

In some embodiments, operation 306 may be performed in accordance with the operations described by FIG. 7. Turning now to FIG. 7, a procedure 700 illustrates example operations for generating a user proficiency profile.

As shown by operation 702, the apparatus 200 includes means, such as processor 202, memory 204, communications hardware 206, multimodal engine 210, or the like, for identifying user proficiency areas based on the proficiency area extraction algorithm. In some embodiments, the memory 204 may store a proficiency area extraction algorithm that stores instructions on how to identify user proficiency areas based on the user attribute set. Example methods from proficiency area identification may involve the following techniques and analyses: (i) natural language processing and text analysis to identify key terms, skills, and achievements related to different proficiency areas, (ii) clustering algorithms, such as K-means or hierarchical clustering to group similar attributes of an overarching proficiency area together, (iii) machine learning classification wherein a machine learning classifier is trained to categorize user attributes from the user attribute set into predefined proficiency areas, (iv) topic modeling wherein, latent dirichlet allocation (LDA) may be used to identify latent proficiency areas within the user attribute set, (v) statistical analyses such as correlation or factor analysis, to identify patterns or relationships among user attributes as proficiency areas may emerge based on co-occurrence or correlations, (v) semantic similarity measurement as user attributes with high similarity may belong to the same proficiency area, and/or the like. The processor 202 may deploy the proficiency area extraction algorithm, in conjunction with the multimodal engine 210 which may receive the results of the identified user proficiency areas. The communications hardware 206 may store the identified user proficiency areas in memory 204 for future retrieval and/or analysis by the multimodal engine 210.

As shown by operation 704, the apparatus 200 includes means, such as processor 202, memory 204, communications hardware 206, multimodal engine 210, or the like, for generating the user proficiency profile based on the identified user proficiency areas. In particular, the multimodal engine 210 may generate the user proficiency profile to comprise the one or more user proficiency areas, wherein each user proficiency area comprises one or more user proficiency attributes as identified using the optimal proficiency identification model.

Returning to FIG. 3, as shown by operation 308, the apparatus 200 includes means such as processor 202, memory 204, communications hardware 206, multimodal engine 210, or the like, for using the optimal proficiency identification model for identifying an underdeveloped proficiency area based on the one or more user proficiency attributes from the one or more user proficiency areas.

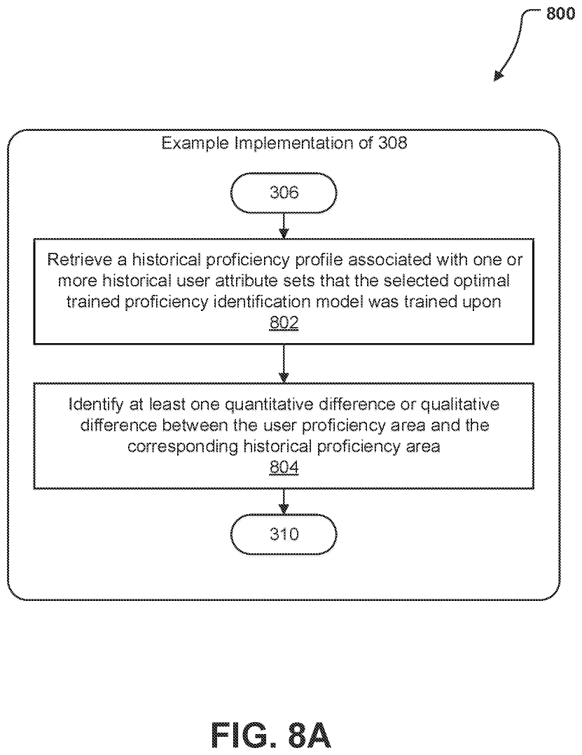

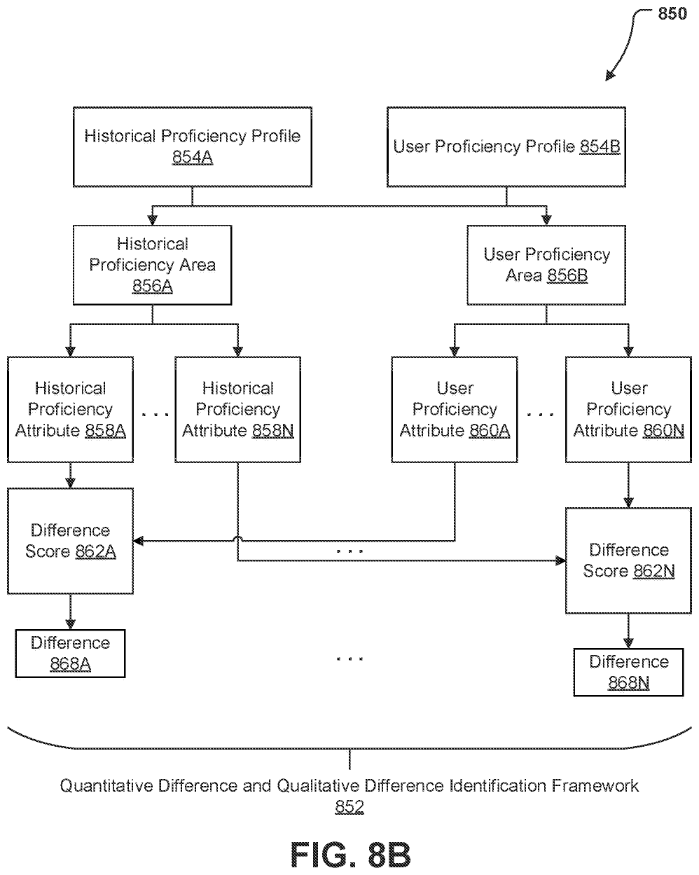

In some embodiments, operation 308 may be performed in accordance with the operations described in FIG. 8A. Turning now to FIG. 8A, a procedure 800 illustrates example operations for identifying an underdeveloped proficiency area based on the one or more user proficiency attributes from the one or more user proficiency areas.

As shown by operation 802, the apparatus 200 includes means, such as processor 202, memory 204, communications hardware 206, multimodal engine 210, or the like, for retrieving a historical proficiency profile associated with one or more historical user attribute sets that the selected optimal proficiency identification model was trained upon, wherein the historical proficiency profile comprises one or more historical proficiency areas, wherein each historical proficiency area (i) comprises one or more historical proficiency attributes, (ii) and is associated with a historical proficiency area score. A historical proficiency profile may be a comprehensive representation of a historical user's proficiency across various historical proficiency areas. The historical proficiency profile may encompass information about the historical user's strengths, weaknesses, and levels of competence in specific proficiency areas. A historical proficiency area may be a distinct domain or category that encapsulates different aspects of a historical user's skills, knowledge, or achievements. Each historical proficiency area provides insights into the historical user's proficiency in a specific context. Examples of historical proficiency areas may include financial literacy, career development, health and wellness, and/or the like. A historical proficiency attribute may be the individual characteristics or metrics within a historical proficiency area that contribute to assessing the historical user's proficiency level. These historical proficiency attributes may provide detailed insights into different facets of the historical user's capabilities. Examples of historical proficiency attributes may include (i) financial literacy attributes such as budgeting, investment knowledge, debt management, (ii) career development attributes such as skill acquisition, networking, goal setting, (iii) health and wellness attributes such as physical fitness, stress management, nutritional awareness, and/or the like.

The processor 202 may store a historical proficiency area extraction algorithm that stores instructions on how to identify historical proficiency areas based on the historical user attribute set. Example methods for historical proficiency area identification may involve the following techniques and analyses: (i) natural language processing and text analysis to identify key terms, skills, and achievements related to different proficiency areas, (ii) clustering algorithms, such as K-means or hierarchical clustering to group similar attributes of an overarching historical proficiency area together, (iii) machine learning classification wherein a machine learning classifier is trained to categorize historical user attributes from the historical user attribute set into predefined historical proficiency areas, (iv) topic modeling wherein, latent dirichlet allocation (LDA) may be used to identify latent historical proficiency areas within the historical user attribute set, (v) statistical analyses such as correlation or factor analysis, to identify patterns or relationships among historical user attributes, as historical proficiency areas may emerge based on co-occurrence or correlations, (v) semantic similarity measurement as historical user attributes with high similarity may belong to the same historical proficiency area, and/or the like. The processor 202 may work with the multimodal engine 210 to deploy the historical proficiency area extraction algorithm, wherein the multimodal engine 210 may receive the results of the identified historical proficiency areas. The communications hardware 206 may store the identified historical proficiency areas in memory 204 for future retrieval and/or analysis by the multimodal engine 210.

Finally, as shown by operation 804, the apparatus 200 includes means, such as processor 202, memory 204, communications hardware 206, multimodal engine 210, or the like for using the optimal proficiency identification model to identify at least one quantitative difference or qualitative difference between each user proficiency area and a corresponding historical proficiency area, wherein the at least one quantitative difference or qualitative difference is indicative of the underdeveloped proficiency area. Examples of quantitative differences may include differences in salary, differences in retirement savings, differences in credit history, and/or the like. Examples of qualitative differences may include differences in socioeconomic backgrounds, differences in educational background, and/or the like. In some embodiments, operation 804 may be performed in reference to the schematic block diagram illustrated in FIG. 8B.

In some embodiments, the processor 202 may preprocess each user proficiency area (e.g., 856B) from a user proficiency profile 854B, to prepare them for subsequent comparison analyses against a corresponding historical proficiency area (e.g., 856A). In example embodiments, the processor 202 may preprocess the historical proficiency area 856A by performing the following: (i) data cleaning by identifying and handing missing or erroneous data in the historical proficiency area 856A, (ii) normalization/scaling by standardizing numerical historical proficiency attributes 858A-858N to a common scale, thereby ensuring that all historical proficiency attributes 858A-858N contribute equally to the subsequent comparison analysis, (iii) feature engineering by creating new relevant features or by modifying existing ones to enhance the information available for analysis, (iv) outlier detection and handling to prevent them from disproportionately influencing the analysis, (v) data encoding by converting categorical variables into a numerical format suitable for analysis, (vi) dimensionality reduction by reducing the number of historical proficiency attributes 858A-858N while preserving relevant information, (vii) temporally aligning the historical proficiency attributes 858A-858N to make them comparable with the user proficiency attributes 860A-860N, (viii) aggregating data to provide a generalized view of historical trends, (ix) handling sequential historical proficiency attributes to account for the temporal order of events, and/or the like.

Memory 204 may store one or more proficiency comparison algorithms. As such, in some embodiments, the communications hardware 206 may access memory 204 to deploy the optimal proficiency comparison algorithm from the one or more proficiency comparison algorithms that is optimally configured to compare each of the one or more user proficiency areas (e.g., 856B) against the corresponding historical proficiency area (856A). The optimal proficiency comparison algorithm may comprise a set of instructions that specify the optimal method for comparing the each of the one or more user proficiency areas (e.g., 856B) against the corresponding historical proficiency area (856A), and by way of doing so, identifies at least one quantitative difference or qualitative difference 868A-868N between each of the one or more user proficiency areas (e.g., 856B) and the corresponding historical proficiency area (e.g., 856A). In some embodiments, the selection of the proficiency comparison method may depend on the characteristics of the user proficiency area (e.g., 856B), the desired level of granularity, and the specific aspects of similarity that have been identified by multimodal engine 210 as being the most relevant to the user's proficiency improvement goals. Example methods for performing the proficiency comparison may include the following: (i) performing similarity metrics analysis, (ii) clustering analysis, (iii) pattern recognition techniques, (iv) deploying a classification model, (v) performing a time series analysis, (vi) embedding techniques, (vii) neural network analyses, and/or the like. In some embodiments, the proficiency comparison algorithm may combine multiple methods to enhance the accuracy and robustness of the proficiency comparison analysis. Upon the completion of the proficiency comparison analysis, the multimodal engine 210 may calculate a difference score for each of the one or more user proficiency areas (e.g., 856B) against the corresponding historical proficiency area (e.g., 856A).

In some embodiments, calculating a difference score 862A-862N may involve (i) assigning weights to individual user proficiency attributes 860A-860N and historical proficiency attributes 858A-858N based on their importance, and determining the weighted sum, (ii) performing feature-level aggregation wherein difference scores are aggregated at the feature level before computing an overall difference score 862A-862N, (iii) employing a custom scoring function that captures the specific characteristics of the historical proficiency areas (e.g., 856A) and the user proficiency areas (e.g., 856B), (iv) threshold based scoring wherein predefined thresholds are set to categorize to degree of difference, and/or the like. The calculated difference score may be represented as a numerical value (e.g., user proficiency area 1 is 50% different than the corresponding historical proficiency area 1), a string of text (e.g., “user proficiency area 1 is different than the corresponding historical proficiency area 1 as historical users of the same age and educational background have a debt-to-income ratio of 40% at 35 years of age, whereas the user has a debt-to-income ratio of 70%”), a combination of both numerical values and a string of text, and/or the like.

Upon determining at least one quantitative difference and/or one qualitative difference between each of the one or more proficiency areas (e.g., 856B) and a corresponding historical proficiency area (e.g., 856A), the multimodal engine 210 may trigger the optimal proficiency identification model to evaluate the significance of the determined quantitative and qualitative differences 868A-868N. For example, in some embodiments, the determined differences 868A-868N may indicate that the historical user was performing better in a certain proficiency area compared to the user. In this case, the multimodal engine 210 may subsequently generate a proficiency development recommendation, in accordance with operation 902 below, wherein the proficiency development recommendation includes recommended user actions for the proficiency areas in which the user demonstrates lower competency, as compared to a historical user. Conversely, in some embodiments, the determined differences may indicate that the historical user was performing worse in a proficiency area than the user. In this case, the multimodal engine 210 may subsequently generate a proficiency development recommendation, in accordance with operation 902 below, wherein the proficiency development recommendation does not include any recommended user actions for the proficiency areas in which the user demonstrates greater competency, as compared to a historical user.

Returning to FIG. 3, as shown by operation 310, the apparatus 200 includes means such as processor 202, memory 204, communications hardware 206, the multimodal engine 210, or the like for outputting a proficiency development recommendation based on the identified underdeveloped proficiency area. In some embodiments, the proficiency development recommendation may include one or more underdeveloped proficiency areas identified in operation 308. The communications hardware 206 may provide the proficiency development recommendation to any one or user devices 112A-112N. In some embodiments, the proficiency development recommendation may present the user with an opportunity to connect with appropriate establishments that may assist them with completing the recommended user actions. For example, if a recommended user action indicates that the user should be investing 15% more in their 401K, the communications hardware 206 may prompt the user to contact the establishment where they have a retirement savings account.

In some embodiments, the multimodal engine 210 may generate the proficiency development recommendation using the optimal proficiency identification model based on the identified underdeveloped proficiency area. The proficiency development recommendation may include one or more recommended user actions that correspond to the one or more identified underdeveloped proficiency areas. In some embodiments, the proficiency development recommendation may further provide instructions for the user to agree with or disagree with the identified underdeveloped proficiency areas. The user may submit in agreement of the proficiency development recommendation indicating that they also recognize a need to improve competency in the identified underdeveloped proficiency areas. The user may submit an option in disagreement of the proficiency development recommendation indicating that they do not recognize the identified underdeveloped proficiency areas as being proficiency areas for which they need to improve competency.

In some embodiments, the underdeveloped proficiency area identification system 102 may monitor user progress in real-time as the user acts upon the recommendations included in the proficiency development recommendation. In particular, the underdeveloped proficiency area identification system 102 may periodically monitor a user account and/or user attributes to detect changes that correspond to the recommendations included in the proficiency development recommendation. The underdeveloped proficiency area identification system 102 may further update the user proficiency profile and subsequently generate one or more modified proficiency development recommendations based on the user's progress in the one or more identified underdeveloped proficiency areas. In particular, the underdeveloped proficiency area identification system 102 may perform the operations described in FIGS. 3-8B above to generate a modified proficiency development recommendations for the user. Additionally, the underdeveloped proficiency area identification system 102 may store an indication of whether the user has successfully performed proficiency development recommendations, such as within a user profile for the user. As such, this may allow a user to monitor his/her progress over time such that he/she may track previously completed proficiency development recommendations as well as current proficiency development recommendations that still need to be performed.

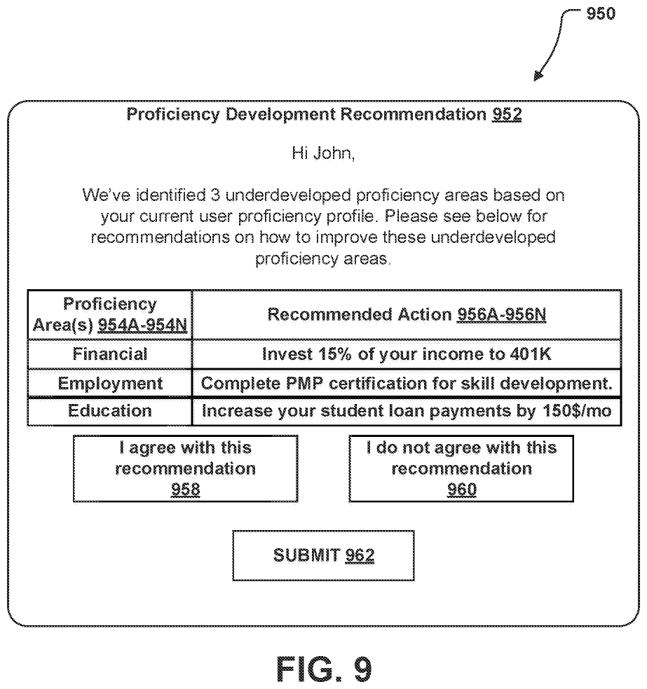

Turning to FIG. 9, a graphical user interface (GUI) is provided that illustrates an example proficiency development recommendation. As noted previously, a user may interact with the underdeveloped proficiency area identification system 102 by directly engaging with communications hardware 206 of an apparatus 200 comprising a system device of the underdeveloped proficiency area identification system 102. In such an embodiment, the GUI shown in FIG. 9 may be displayed to a user by the apparatus 200. Alternatively, a user may interact with the underdeveloped proficiency area identification system 102 using a separate user device (e.g., any of user devices 112A-112N as shown in FIG. 1), which may communicate with the underdeveloped proficiency area identification system 102 via communications network 108. In such an embodiment, the GUI shown in FIG. 9 may be displayed to the user by the user device 112A-112N.

As shown in FIG. 9, a proficiency development recommendation 952 may include identified underdeveloped proficiency areas 954A-954N and a recommended actions 956A-956N for each identified underdeveloped proficiency area. The proficiency development recommendation 952 may also include agreement 958 or disagreement option 960, pertaining to the proficiency development recommendation. The proficiency development recommendation 952 may further include a user interaction element 962 that allows the user to submit their chosen response to the proficiency development recommendation. In instances where a user disagrees with the proficiency development recommendation, the communications hardware 206 may output a secondary prompt to the user, requesting them to explain their reasons for disagreeing with the outputted proficiency development recommendation. The communications hardware 206 may receive the user agreement response 958 or disagreement response 962 and reasons for denial explanation from any of user devices 112A-112N, and store them in memory 204 for improving model confidence during future training of the one or more proficiency identification models.

FIGS. 3-8B illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, example embodiments provide technical solutions designed to systematically identify the underdeveloped proficiency areas for a user. Such solutions have not previously been used, and are only achievable by harnessing the computational capabilities and widespread data accessibility offered by modern internet connectivity. Example embodiments allow establishments to automatically identify underdeveloped proficiency areas without the need for manual inspection or evaluation, and in a more robust and thorough fashion. Moreover, example embodiments save underdeveloped proficiency area identification time and resources in comparison to other possible approaches because they identify underdeveloped proficiency areas only when deemed warranted by a trained proficiency area identification model. Overall, example embodiments thus enhance the process for the identifications of underdeveloped proficiency areas, while eliminating the possibility of human error that would be otherwise unavoidable. Finally, by automating functionality that has historically required human analysis and judgement, the speed and consistency of the evaluations performed by example embodiments unlocks many potential new functions that have historically not been available, such as by identifying underdeveloped proficiency areas for users in response to real-time occurrences of life events, this could not historically be accounted for in any systematic fashion.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for identification of an underdeveloped proficiency area for a user, the method comprising:
generating, by mining engine, a user attribute set, wherein the user attribute set comprises one or more user attributes;
selecting, by the mining engine and based on the user attribute set, an optimal proficiency identification model;
generating, by multimodal engine and using the optimal proficiency identification model and based on the user attribute set, a user proficiency profile;
identifying, by the multimodal engine and using the optimal proficiency identification model, an underdeveloped proficiency area based on the one or more user proficiency attributes from the one or more user proficiency areas; and
outputting, by communications hardware and based on the identified underdeveloped proficiency area, a proficiency development recommendation.

2. The method of claim 1, wherein generating a user attribute set further comprises:
extracting, by the mining engine, the one or more user attributes pertaining to the user from a plurality of data environments;
assigning, by the mining engine, the one or more user attributes into one or more user attribute types;
determining, by the mining engine and based on the one or more user attribute types, a plurality of inter-attribute type relationships and intra-attribute type relationships; and
generating, by the mining engine and based on the plurality of inter-attribute type relationships and intra-attribute type relationships, the user attribute set.

3. The method of claim 1, wherein selecting the optimal proficiency identification model further comprises:
identifying, by the mining engine, one or more historical user attribute sets, wherein the one or more historical user attribute sets are associated with one or more trained proficiency identification models;
calculating, by the mining engine, a similarity score for each of the one or more historical user attribute sets, wherein the similarity score is a measure of similarity between the one or more historical user attribute sets and the user attribute set; and
select, by the mining engine, an optimal proficiency identification model from the one or more trained proficiency identification models, wherein the similarity score of the one or more historical user attribute sets associated with the selected optimal proficiency identification model satisfy a predefined threshold.

4. The method of claim 3, further comprising:
training, by a multimodal engine, one or more proficiency identification models based on one or more historical user attribute sets, wherein the one or more trained proficiency identification models are associated with the one or more historical user attribute sets used during training.

5. The method of claim 1, wherein generating the user proficiency profile further comprises:
determining, by the multimodal engine and using the optimal proficiency identification model, a user proficiency profile, wherein the user proficiency profile comprises one or more user proficiency areas, wherein each user proficiency area comprises one or more user proficiency attributes.

6. The method of claim 1, wherein identifying the underdeveloped proficiency area further comprises:
retrieving, by the multimodal engine, a historical proficiency profile associated with one or more historical user attribute sets that the selected optimal proficiency identification model was trained upon, wherein the historical proficiency profile comprises one or more historical proficiency areas, wherein each historical proficiency area (i) comprises one or more historical proficiency attributes, (ii) and is associated with a historical proficiency area score; and
identifying, by the multimodal engine and using the optimal proficiency identification model, at least one quantitative difference or qualitative difference between each user proficiency area and the corresponding historical proficiency area, wherein the at least one quantitative difference or qualitative difference is indicative of the underdeveloped proficiency area.

7. The method of claim 1, further comprising:
generating, by the multimodal engine and using the optimal proficiency identification model, the proficiency development recommendation based on the identified underdeveloped proficiency area, wherein the proficiency development recommendation comprises one or more recommended user actions for the identified underdeveloped proficiency area.

8. An apparatus for identification of an underdeveloped proficiency area for a user, the apparatus comprising:
a mining engine configured to:
generate a user attribute set, wherein the user attribute set comprises one or more user attributes, and
select, based on the user attribute set, an optimal proficiency identification model;
a multimodal engine configured to:
generate, using the optimal proficiency identification model and based on the user attribute set, a user proficiency profile, wherein the user proficiency profile comprises one or more user proficiency areas, wherein each user proficiency area comprises one or more user proficiency attributes, and
identify, using the optimal proficiency identification model, an underdeveloped proficiency area based on the one or more user proficiency attributes from the one or more user proficiency areas; and
communications hardware configured to:
output, based on the identified underdeveloped proficiency area, a proficiency development recommendation.

9. The apparatus of claim 8, wherein the mining engine is further configured to:
extract the one or more user attributes pertaining to the user from a plurality of data environments;
assign the one or more user attributes into one or more user attribute types;
determine, based on the one or more user attribute types, a plurality of inter-attribute type relationships and intra-attribute type relationships; and
generate, based on the plurality of inter-attribute type relationships and intra-attribute type relationships, the user attribute set.

10. The apparatus of claim 8, wherein the mining engine is further configured to:
identify, one or more historical user attribute sets, wherein the one or more historical user attribute sets are associated with one or more trained proficiency identification models;
calculate a similarity score for each of the one or more historical user attribute sets, wherein the similarity score is a measure of similarity between the one or more historical user attribute sets and the user attribute set; and
select an optimal proficiency identification model from the one or more trained proficiency identification models, wherein the similarity score of the one or more historical user attribute sets associated with the selected optimal proficiency identification model satisfy a predefined threshold.

11. The apparatus of claim 10, wherein the multimodal engine is further configured to:
train, one or more proficiency identification models based on one or more historical user attribute sets, wherein the one or more trained proficiency identification models are associated with the one or more historical user attribute sets used during training.

12. The apparatus of claim 8, wherein the multimodal engine is further configured to:
determine, using the optimal proficiency identification model, a user proficiency profile, wherein the user proficiency profile comprises one or more user proficiency areas, wherein each user proficiency area comprises one or more user proficiency attributes.

13. The apparatus of claim 8, wherein the multimodal engine is further configured to:
retrieve a historical proficiency profile associated with the one or more historical user attribute sets that the selected optimal proficiency identification model was trained upon, wherein the historical proficiency profile comprises one or more historical proficiency areas, wherein each historical proficiency area (i) comprises one or more historical proficiency attributes, (ii) and is associated with a historical proficiency area score; and
identify, using the optimal proficiency identification model, at least one quantitative difference or qualitative difference between each user proficiency area and the corresponding historical proficiency area, wherein the at least one quantitative difference or qualitative difference is indicative of the underdeveloped proficiency area.

14. The apparatus of claim 8, wherein the multimodal engine is further configured to:
generate, using the optimal proficiency identification model, the proficiency development recommendation based on the identified underdeveloped proficiency area, wherein the proficiency development recommendation comprises one or more recommended user actions for the identified underdeveloped proficiency area.

15. A computer program product for identification of an underdeveloped proficiency area for a user, the computer program product comprising at least one non-transitory computer readable storage medium storing software instructions that, when executed, cause an apparatus to:
generate a user attribute set, wherein the user attribute set comprises one or more user attributes;
select, based on the user attribute set, an optimal proficiency identification model;
generate, using the optimal proficiency identification model and based on the user attribute set, a user proficiency profile, wherein the user proficiency profile comprises one or more user proficiency areas, wherein each user proficiency area comprises one or more user proficiency attributes;
identify, using the optimal proficiency identification model, an underdeveloped proficiency area based on the one or more user proficiency attributes from the one or more user proficiency areas; and
output, based on the identified underdeveloped proficiency areas, a proficiency development recommendation.

16. The computer program product of claim 15, wherein the software instructions, when executed, further cause the apparatus to:
identify, one or more historical user attribute sets, wherein the one or more historical user attribute sets are associated with one or more trained proficiency identification models;
calculate a similarity score for each of the one or more historical user attribute sets, wherein the similarity score is a measure of similarity between the one or more historical user attribute sets and the user attribute set; and
select an optimal proficiency identification model from the one or more trained proficiency identification models, wherein the similarity score of the one or more historical user attribute sets associated with the selected optimal proficiency identification model satisfy a predefined threshold.

17. The computer program product of claim 16, wherein the software instructions, when executed, further cause the apparatus to:
train, one or more proficiency identification models based on one or more historical user attribute sets, wherein the one or more trained proficiency identification models are associated with the one or more historical user attribute sets used during training.

18. The computer program product of claim 15, wherein the software instructions, when executed, further cause the apparatus to:
determine, using the optimal proficiency identification model, a user proficiency profile, wherein the user proficiency profile comprises one or more user proficiency areas, wherein each user proficiency area comprises one or more user proficiency attributes.

19. The computer program product of claim 15, wherein the software instructions, when executed, further cause the apparatus to:
retrieve a historical proficiency profile associated with the one or more historical user attribute sets that the selected optimal proficiency identification model was trained upon, wherein the historical proficiency profile comprises one or more historical proficiency areas, wherein each historical proficiency area (i) comprises one or more historical proficiency attributes, (ii) and is associated with a historical proficiency area score; and
identify, using the optimal proficiency identification model, at least one quantitative difference or qualitative difference between each user proficiency area and a corresponding historical proficiency area, wherein the at least one quantitative difference or qualitative difference is indicative of the underdeveloped proficiency area.

20. The computer program product of claim 15, wherein the software instructions, when executed, further cause the apparatus to:
generate, using the optimal proficiency identification model, the proficiency development recommendation based on the identified underdeveloped proficiency area, wherein the proficiency development recommendation comprises one or more recommended user actions for the identified underdeveloped proficiency area.
